(19) United States
(12) Patent Application Publication
(10) Pub. No.: US 2016/0034080 A1
(43) Pub. Date: Feb. 4, 2016

(54) SEMICONDUCTOR DEVICE AND METHOD OF OPERATING THE SAME

(71) Applicants: Jin-Chul LEE, Seoul (KR); Sang-Hyub KANG, Yongin-si (KR); San-Ho BYUN, Bucheon-si (KR); Cha-Dong KIM, Gwacheon-si (KR); Bum-Soo KIM, Seoul (KR); Jun-Chul PARK, Daegu (KR); Hyun-Kyu OUH, Yongin-si (KR); Yoon-Kyung CHOI, Seoul (KR)

(72) Inventors: Jin-Chul LEE, Seoul (KR); Sang-Hyub KANG, Yongin-si (KR); San-Ho BYUN, Bucheon-si (KR); Cha-Dong KIM, Gwacheon-si (KR); Bum-Soo KIM, Seoul (KR); Jun-Chul PARK, Daegu (KR); Hyun-Kyu OUH, Yongin-si (KR); Yoon-Kyung CHOI, Seoul (KR)

(21) Appl. No.: 14/816,168

(22) Filed: Aug. 3, 2015

Related U.S. Application Data
(60) Provisional application No. 62/032,078, filed on Aug. 1, 2014.

(30) Foreign Application Priority Data
Apr. 3, 2015 (KR) 10-2015-0047372

(51) Int. Cl. G06F 3/047; G09G 5/00; G09G 5/18; G06F 3/044

(52) U.S. Cl. CPC G06F 3/047; G06F 3/044; G09G 5/003; G09G 5/18; G09G 2300/0426

(57) ABSTRACT

A semiconductor device includes a touch screen panel including a plurality of hover sensors configured to perform self-capacitance sensing. The semiconductor memory device includes a driver configured to provide a plurality of driving signals to the touch screen panel. The semiconductor memory device includes an encoder configured to encode the plurality of driving signals from the driver and provide the encoded plurality of driving signals to the touch screen panel. The semiconductor memory device includes a sensor configured to sense a hover input from the touch screen panel based on the encoded plurality of driving signals.

### CROSS-REFERENCE TO RELATED APPLICATION

This application claims priorities from U.S. Provisional Patent Application No. 62/032,078 filed on Aug. 1, 2014 in the US Patent Trademark Office, and Korean Patent Application No. 10-2015-0047372 filed on Apr. 3, 2015 in the Korean Intellectual Property Office, the disclosure of which is incorporated herein by reference in its entirety.

### BACKGROUND

1. Field

Inventive concepts relate to a semiconductor device and/or a method of operating the same.

2. Description of the Related Art

A touch input or space input may be received from a touch screen panel in order to control an electronic apparatus according to a user's intention. In particular, since a space input generated according to spatial movement of an object or at least a portion of a user's body is sensed by a signal having a level lower than that of a touch input, it is desired to improve a degree of precision in sensing, in particular, a space input (that is, a hover input).

### SUMMARY

At least one example embodiment of inventive concepts may provide a semiconductor device, allowing for improvements in a degree of precision in sensing a space input or a hover input to a touch screen panel as well as allowing for miniaturization of a driving circuit in the touch screen panel.

At least one example embodiment of the inventive concepts may provide a method of operating a semiconductor device, allowing for improvements in a degree of precision in sensing a space input or a hover input to a touch screen panel as well as allowing for miniaturization of a driving circuit in the touch screen panel.

According to at least one example embodiment, a semiconductor device includes a touch screen panel including a plurality of hover sensors configured to perform self-capacitance sensing. The semiconductor device includes a driver configured to provide a plurality of driving signals to the touch screen panel. The semiconductor device includes an encoder configured to encode the plurality of driving signals from the driver and provide the encoded plurality of driving signals to the touch screen panel. The semiconductor device includes an event sensor configured to sense a hover input from the touch screen panel based on the encoded plurality of driving signals.

According to at least one example embodiment, a semiconductor device includes a touch screen panel including a plurality of hover sensors configured to perform self-capacitance sensing. The semiconductor device includes a driver configured to provide a single driving signal to the touch screen panel. The semiconductor device includes a decoder configured to decode a sensing signal into a plurality of sensing signals based on the single driving signal. The semiconductor device includes an event sensor configured to sense a hover input from the touch screen panel based on the plurality of sensing signals.

According to at least one example embodiment, a method of operating a semiconductor device includes generating a first driving signal and a second driving signal for driving a touch screen panel including a plurality of hover sensors. The method includes encoding the first driving signal with a first code, and encoding the second driving signal with a second code, different from the first code. The method includes sending the encoded first driving signal and the encoded second driving signal to the touch screen panel.

According to at least one example embodiment, a method of operating a semiconductor device includes generating a first driving signal and a second driving signal for driving a touch screen panel including a plurality of hover sensors. The method includes first encoding, at a first time, the first driving signal and the second driving signal to generate a first encoded driving signal and a second encoded driving signal, the first encoded driving signal being encoded with a first code, the second encoded driving signal being encoded with a second code. The method includes first sensing a hover input from the touch screen panel using the first encoded first driving signal and the second encoded second driving signal. The method includes second encoding, at a second time subsequent to the first time, the first driving signal and the second driving signal to generate a third encoded driving signal and a fourth encoded driving signal, the third encoded driving signal being encoded with a second code, the fourth encoded driving signal being encoded with a third code. The method includes second sensing the hover input from the touch screen panel using the third encoded driving signal and the fourth encoded driving signal.

According to at least one example embodiment, a semiconductor device includes a driver configured to generate at least one driving signal. The semiconductor device includes an encoder configured to encode the at least one driving signal and send the encoded at least one driving signal to a touch screen panel. The touch screen panel includes a plurality of hover sensors configured to perform self-capacitance sensing based on the at least one driving signal to detect a hover event. The semiconductor device includes an event sensor configured to sense the hover event based on output of the hover sensors.

### BRIEF DESCRIPTION OF DRAWINGS

The above and other aspects and features of the inventive concepts will become more apparent by describing in detail example embodiments thereof with reference to the attached drawings, in which:

FIG. 1 is a schematic diagram illustrating a touch screen panel according to at least one example embodiment of the inventive concepts.

FIG. 2 is a schematic diagram illustrating a semiconductor device according to at least one example embodiment of the inventive concepts.

FIG. 3 is a schematic diagram illustrating operations of a semiconductor device according to at least one example embodiment of the inventive concepts.

FIG. 4 is a schematic diagram illustrating a circuit for driving a semiconductor device according to at least one example embodiment of the inventive concepts.

FIG. 5 is a schematic diagram illustrating encoding a driving signal according to at least one example embodiment of the inventive concepts.

FIG. 6 is a time flowchart illustrating operations of a semiconductor device according to at least one example embodiment of the inventive concepts.

FIG. 7 is a schematic diagram illustrating an operation of performing hover sensing according to at least one example embodiment of the inventive concepts.

FIG. 8 is a schematic diagram illustrating a semiconductor device according to at least one example embodiment of the inventive concepts.

FIG. 9 is a schematic diagram illustrating a circuit for driving the semiconductor device according to at least one example embodiment of the inventive concepts.

FIG. 10 through FIG. 12 are example semiconductor systems to which the semiconductor devices according to at least one example embodiment of the inventive concepts are applicable.

### DETAILED DESCRIPTION OF EXAMPLE EMBODIMENTS

Inventive concepts will now be described more fully with reference to the accompanying drawings, in which example embodiments of are shown. These example embodiments are provided so that this disclosure will be thorough and complete, and will fully convey inventive concepts of to those skilled in the art. Inventive concepts may be embodied in many different forms with a variety of modifications, and a few embodiments will be illustrated in drawings and explained in detail. However, this should not be construed as being limited to example embodiments set forth herein, and rather, it should be understood that changes may be made in these example embodiments without departing from the principles and spirit of inventive concepts, the scope of which are defined in the claims and their equivalents. Like numbers refer to like elements throughout. In the drawings, the thicknesses of layers and regions are exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., electronic imaging systems, image processing systems, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible or non-transitory machine readable mediums for storing information. The term “computer-readable medium” may include, but is not limited to, portable or fixed storage devices, optical storage devices, and various other tangible or non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “includes”, “including”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items. Expressions such as “at least one of,” when preceding a list of elements, modify the entire list of elements and do not modify the individual elements of the list.

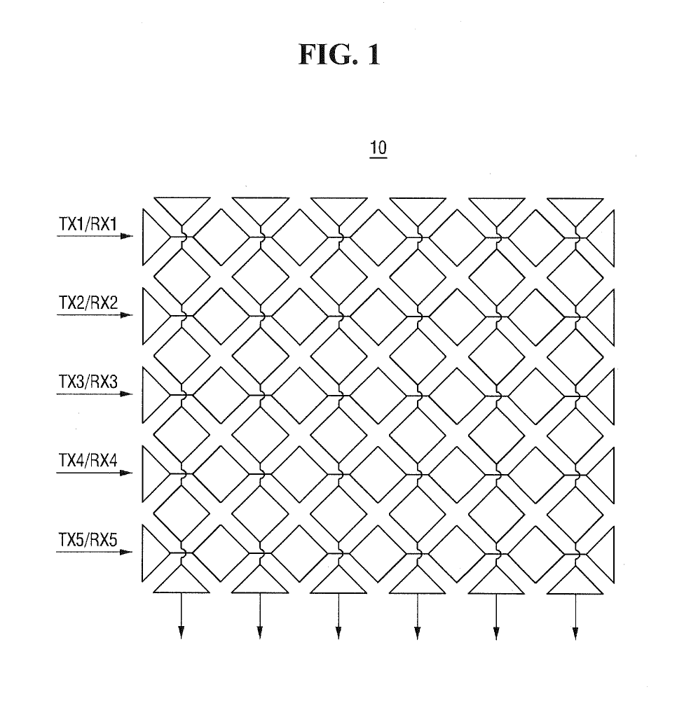

FIG. 1 is a schematic diagram illustrating a touch screen panel according to at least one example embodiment of the inventive concepts.

Referring to FIG. 1, a touch screen panel 10 according to at least one example embodiment of the inventive concepts may have first lines extending in a first direction, for example, a horizontal direction, and second lines extending in a second direction, for example, a vertical direction, to intersect the first lines. Meanwhile, the touch screen panel 10 may include a plurality of hover sensors performing self-capacitance sensing, formed by the first and second lines. Here, the hover sensor is a device for sensing a space input (that is, a hover input or hover event) generated as a user's body or an object moves into a space above the touch screen panel 10 without touching the touch screen panel 10. The second lines may be lines for detecting touches on the touch screen panel 10.

The lines of the touch screen panel 10 adjacent to each other in the first direction may operate as TX lines to which driving signals of the touch screen panel 10 are applied or may operate as RX lines through which electrical charges are received from the hover sensors. For example, a TX driving signal TX1 and an RX sensing signal RX1 may be applied to the uppermost first line extended in a horizontal direction of FIG. 1, and a TX driving signal TX2 and an RX sensing signal RX2 may be applied to the first line disposed immediately below the uppermost first line. That is, the touch screen panel 10 may apply the TX driving signal to at least a portion of the first lines and may lead the RX sensing signal through the at least a partial line.

In at least one example embodiment of the inventive concepts, the touch screen panel 10 may be a capacitive touch screen, but is not limited thereto.

Meanwhile, in at least one example embodiment of the inventive concepts, the touch screen panel 10 may be an attached panel, a cover window-integrated panel or a display-integrated panel. For example, in the case of the attached panel, the touch screen panel 10 may include a lower substrate including a pixel array and an upper substrate such as a glass substrate, and the touch screen panel 10 may be disposed between the lower substrate and the upper substrate of the display panel. Unlike this, in the case of the cover window-integrated panel, for example, the touch screen panel 10 may be formed by patterning transparent electrodes deposited on a cover window. Unlike this, in the case of the display-integrated panel, the touch screen panel 10 may be formed by patterning transparent electrodes on a display itself.

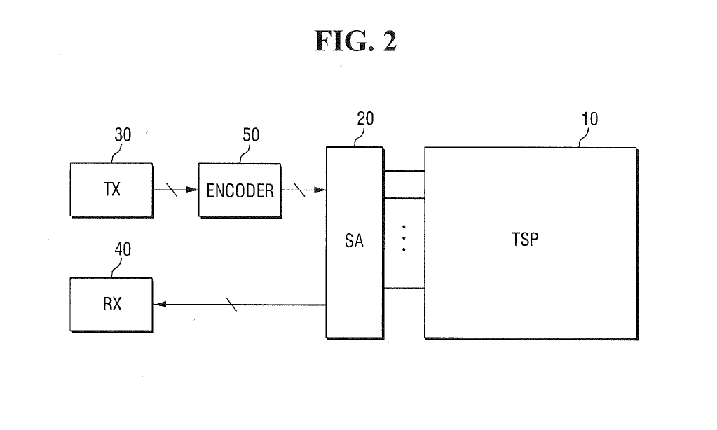

FIG. 2 is a schematic diagram illustrating a semiconductor device according to at least one example embodiment of the inventive concepts.

Referring to FIG. 2, the semiconductor device according to at least one example embodiment of the inventive concepts may include the touch screen panel 10, a TX driver 30, an RX sensor (or event sensor) 40, and an encoder 50. In at least one example embodiment of the inventive concepts, the semiconductor device may further include a switch array (SA) 20.

The TX driver 30 may provide one or more driving signals to the touch screen panel 10. Referring to FIG. 1, the TX driver 30 may provide one or more driving signals to the touch screen panel 10 through the first lines, or a portion of the first lines extended in the horizontal direction in the touch screen panel 10.

The RX sensor 40 may sense a hover input (or hover event) from the touch screen panel 10. Referring to FIG. 1 together with FIG. 2, the RX sensor 40 may sense a hover input from the hover sensor through the first line, or a portion of the first lines extended in the horizontal direction in the touch screen panel 10.

The encoder 50 may encode one or more driving signals provided from the TX driver 30. The encoder 50 may also provide the encoded one or more driving signals to the touch screen panel 10. A concrete description of encoding one or more driving signals by the encoder 50 will be described later.

The switch array (SA) 20 may receive one or more driving signals from the TX driver 30 and may distribute the one or more driving signals to a portion of the first lines. Specifically, the switch array (SA) 20 may include a plurality of multiplexers for distributing the one or more driving signals to the first lines.

In at least one example embodiment of the inventive concepts, the TX driver 30, the RX sensor 40, and the encoder 50 may be integrated as a single read-out integrated circuit (ROIC).

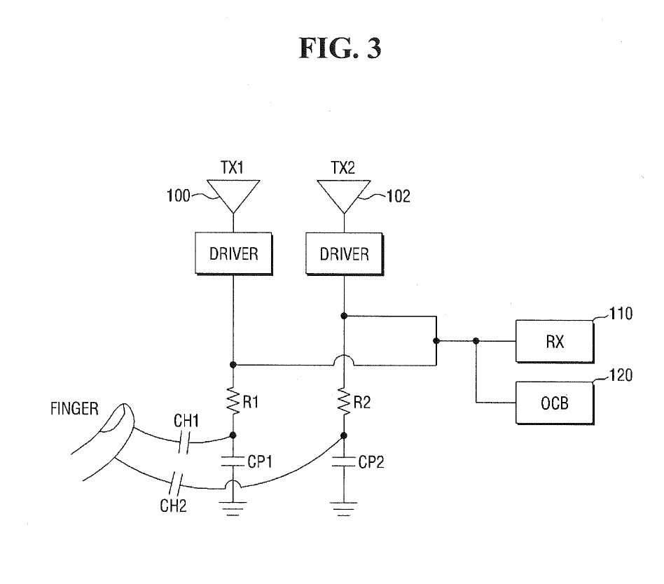

FIG. 3 is a schematic diagram illustrating operations of a semiconductor device according to at least one example embodiment of the inventive concepts.

Referring to FIG. 3, in self-capacitance sensing, hovering capacitances CH1 and CH2 may be formed between the touch screen panel 10 and a user's body, for example, a finger, or an object. Meanwhile, parasitic capacitances CP1 and CP2 may be present in the lines of the touch screen panel 10 on which hover sensing is performed. Here, the hovering capacitance is formed by air having a low dielectric constant, such that a capacity of the capacitance is low, and the hover sensing is performed on a sensing signal having a minute variance. Resistors R1 and R2 may represent parasitic resistances in the lines of the touch screen panel 10 on which hover sensing is performed.

In at least one example embodiment of the inventive concepts, a first driving signal TX1 and a second driving signal TX2 generated by a first driving signal generator 100 and a second driving signal generator 200 may be provided to the touch screen panel 10, and an RX sensor 110 may receive the sensing signal obtained by the hover sensor. Meanwhile, an offset calibration block (OCB) 120 may perform hover sensing and subsequently, may adjust an offset of the driving signal for hover sensing.

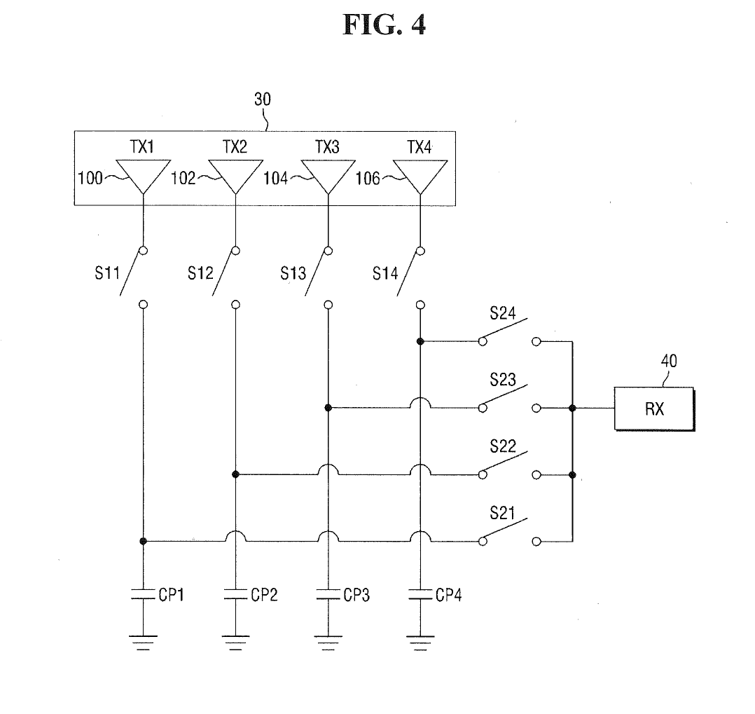

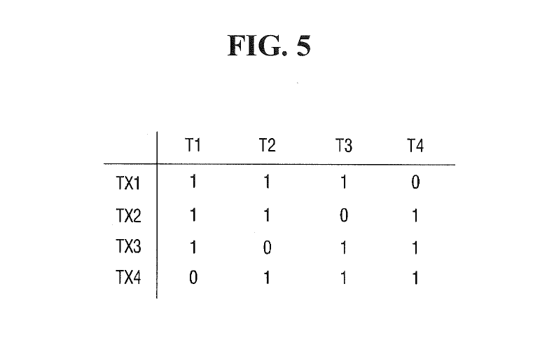

FIG. 4 is a schematic diagram illustrating a circuit for driving a semiconductor device according to at least one example embodiment of the inventive concepts. FIG. 5 is a schematic diagram illustrating encoding a driving signal according to at least one example embodiment of the inventive concepts.

Referring to FIG. 4, the semiconductor device according to at least one example embodiment of the inventive concepts may include a plurality of switches for encoding first to fourth driving signals TX1, TX2, TX3, and TX4 between the TX driver 30 and the RX sensor 40. Specifically, switches S11, S12, S13, and S14 may be provided at one ends of first to fourth driving signal generators 100, 102, 104, and 106 to which driving signals are provided. In addition, switches S21, S22, S23, and S24 may be provided between the RX sensor 40 and the lines of the touch screen panel 10 in which the hover sensors are formed.

Referring to FIG. 5, the encoder 50 may encode the first to fourth driving signals TX1, TX2, TX3, and TX4 using the switches S11, S12, S13, S14, S21, S22, S23, and S24. Specifically, the encoder 50 may encode the first to fourth driving signals TX1, TX2, TX3, and TX4 into (‘1’, ‘1’, ‘1’, ‘0’) at a time T1, may encode the first to fourth driving signals TX1, TX2, TX3, and TX4 into (‘1’, ‘1’, ‘0’, ‘1’) at a time T2, may encode the first to fourth driving signals TX1, TX2, TX3, and TX4 into (‘1’, ‘0’, ‘1’, ‘1’) at a time T3, and may encode the first to fourth driving signals TX1, TX2, TX3, and TX4 into (‘0’, ‘1’, ‘1’, ‘1’) at a time T4.

Here, the encoding of driving signals means that an amplitude value and/or phase of at least one driving signal among a plurality of driving signals, for example, the first to fourth driving signals TX1, TX2, TX3, and TX4, is differently set (or allowed). Specifically, in at least one example embodiment of the inventive concepts, the encoder 50 may encode the first to fourth driving signals TX1, TX2, TX3, and TX4 in such a manner that amplitude values of the first to third driving signals TX1, TX2, and TX3 are positive values while only an amplitude value of the fourth driving signal TX 4 is a negative value.

Meanwhile, in at least one example embodiment of the inventive concepts, the encoder 50 may encode the first to fourth driving signals TX1, TX2, TX3, and TX4 in such a manner that phases of the first to third driving signals TX1, TX2, and TX3 are different from that of the fourth driving signal TX 4. For example, the encoder 50 may encode the first to fourth driving signals TX1, TX2, TX3, and TX4 in such a manner that a phase of the fourth driving signal TX4 is opposite to phases of the first to third driving signals TX1, TX2, and TX3 by 180°.

Meanwhile, the encoder 50 may encode the first to fourth driving signals TX1, TX2, TX3, and TX4 in such a manner voltage levels of the first to third driving signals TX1, TX2, and TX3 are the highest voltage level while only a voltage level of the fourth driving signal TX 4 is the lowest voltage level.

Meanwhile, as can be seen in FIG. 5, the encoder 50 may encode the first to fourth driving signals TX1, TX2, TX3, and TX4 at individual times T1, T2, T3, and T4 in different methods. Specifically, the encoder 50 may encode the fourth driving signal TX4 into ‘0’ at the first time T1 and then, encode the fourth driving signal TX4 into ‘1’ at the second time T2.

Accordingly, the amplitude value of the fourth driving signal TX4 at the first time T1 may be negative and the amplitude value of the fourth driving signal TX4 at the second time T2 may be positive. Meanwhile, the phase of the fourth driving signal TX4 at the first time T1 may be different from or opposite to the phase of the fourth driving signal TX4 at the second time T2. Further, the voltage level of the fourth driving signal TX 4 at the first time T1 may be the highest voltage level, and the voltage level of the fourth driving signal TX 4 at the second time T2 may be the lowest voltage level.

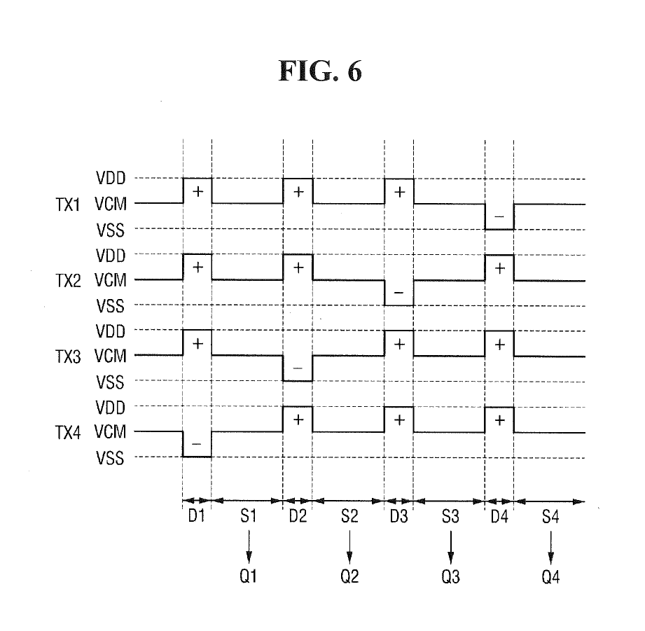

FIG. 6 is a time flowchart illustrating operations of a semiconductor device according to at least one example embodiment of the inventive concepts.

Referring to FIG. 6, the first to fourth driving signal generators 100, 102, 104, and 106 may generate the first to fourth driving signals TX1, TX2, TX3, and TX4 for driving the touch screen panel 10 including the plurality of hover sensors.

Specifically, the encoder 50 may perform first encoding on the first driving signal TX1 to provide a first code (that is, ‘+’) to the first to third driving signals TX1, TX2, and TX3. Meanwhile, the encoder 50 may perform fourth encoding on the fourth driving signal TX4 to provide a fourth code (that is, ‘−’) to the fourth driving signal TX4. The first to fourth driving signals TX1, TX2, TX3, and TX4 respectively encoded may drive the hover sensors of the touch screen panel 10 in a driving section D1. Subsequently, after the RX sensor 40 performs sensing in a sensing section S1, a result Q1 may be obtained. Based on the result Q1, the offset calibration block (OCB) 120 may adjust the offset of the driving signal for subsequent hover sensing in the sensing section S1.

Then, the encoder 50 may provide the ‘+’ code to the first, second and fourth driving signals TX1, TX2, and TX4, while providing the ‘−’ code to the third driving signal TX3. The first to fourth driving signals TX1, TX2, TX3, and TX4 encoded in such a manner may drive the hover sensors of the touch screen panel 10 in a driving section D2. Subsequently, after the RX sensor 40 performs sensing in a sensing section S2, a result Q2 may be obtained.

As mentioned above, the ‘+’ code and the ‘−’ code may be associated with the amplitude value, the phase, the voltage level and the like, of the driving signal. For example, the voltage level of the first driving signal TX1 to which the ‘+’ code is provided may be the highest voltage level VDD, and the voltage level of the fourth driving signal TX4 to which the ‘−’ code is provided may be the lowest voltage level VSS. These voltage levels may be adjusted to a voltage level VCM by the offset calibration block (OCB) in sensing sections S1, S2, S3 and S4.

In FIG. 6, by repeating the above described operations, results Q1, Q2, Q3 and Q4 may be obtained.

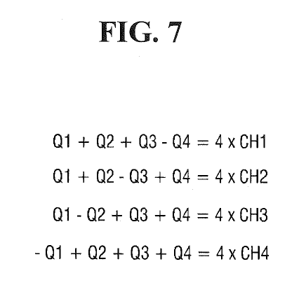

FIG. 7 is a schematic diagram illustrating an operation of performing hover sensing according to at least one example embodiment of the inventive concepts.

Referring to FIG. 7, relationships between the results Q1, Q2, Q3 and Q4 obtained from FIG. 6 and hovering capacitances CH1, CH2, CH3, and CH4 formed between a finger or an object and the touch screen panel 10 may be confirmed. Specifically, over the course of time, the first to fourth driving signals TX1, TX2, TX3, and TX4 are encoded into (‘+’, ‘+’, ‘+’, ‘−’), (‘+’, ‘+’, ‘−’, ‘+’), (‘+’, ‘−’, ‘+’, ‘+’), (‘−’, ‘+’, ‘+’, ‘+’) and perform hover sensing a total of four times. Accordingly, respective results Q1, Q2, Q3 and Q4 are obtained. Thus, a value 4 times that of the hovering capacitance CH1 may correspond to Q1+Q2+Q3−Q4, and a value 4 times that of the hovering capacitance CH2 may correspond to Q1+Q2−Q3+Q4. In a similar manner, a value 4 times that of the hovering capacitance CH3 may correspond to Q1−Q2+Q3+Q4, and a value 4 times that of the hovering capacitance CH4 may correspond to −Q1+Q2+Q3+Q4.

In view of the above, it should be understood that at least one example embodiment of the inventive concepts generates advantageous effects of reducing calibration capacitances while simultaneously increasing a degree of resolution in hover sensing by about 4 times. Moreover, a degree of sensing precision in self-capacitance sensing may be improved and a size of a touch screen channel driving circuit may be reduced.

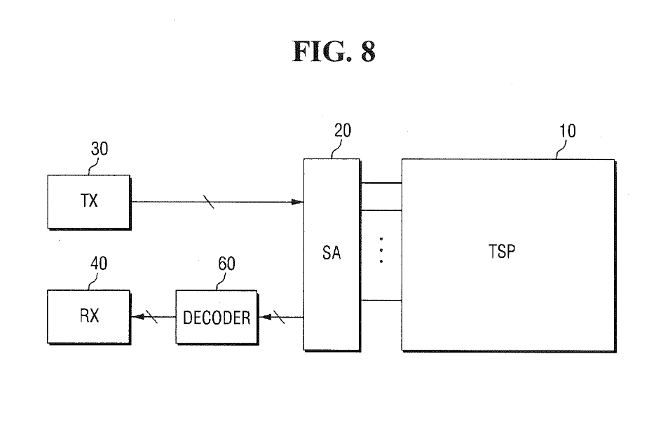

FIG. 8 is a schematic diagram illustrating a semiconductor device according to at least one example embodiment of the inventive concepts.

Referring to FIG. 8, the semiconductor device according to at least one example embodiment of the inventive concepts may include the touch screen panel 10, the TX driver 30, the RX sensor 40, and a decoder 60. In at least one example embodiment of the inventive concepts, the semiconductor device may further include the switch array (SA) 20.

The example embodiment of FIG. 8 is different from that of FIG. 2 in that the TX driver 30 provides a single driving signal to the touch screen panel 10. Further, an example embodiment according to FIG. 8 is different from that of FIG. 2 in that the semiconductor device of FIG. 8 includes the decoder 60.

The decoder 60 may decode a sensing signal for a hover input sensed using a single driving signal generated by the TX driver 30, into a plurality of sensing signals. In addition, the decoder 60 may provide the plurality of sensing signals to the RX sensor 40. In at least one example embodiment of the inventive concepts, a phase of at least one of the plurality of sensing signals may be different from or opposite to that of at least another of the plurality of sensing signals.

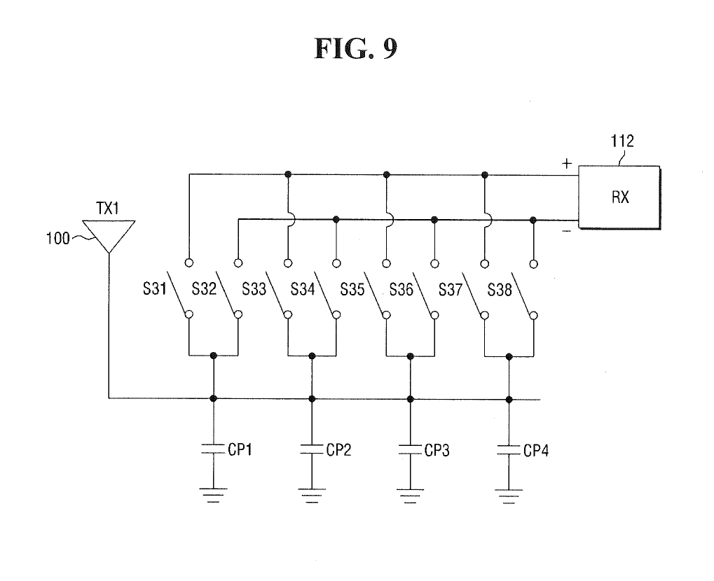

FIG. 9 is a schematic diagram illustrating a circuit for driving the semiconductor device according to at least one example embodiment of the inventive concepts.

Referring to FIG. 8, the semiconductor device according to at least one example embodiment of the inventive concepts may include a plurality of switches S31 to S38 as the decoder 60 for generating the plurality of sensing signals between the TX driver 30 and the RX sensor 40. That is, the decoder 60 may generate the plurality of sensing signals using the plurality of switches S31 to S38.

In at least one example embodiment of the inventive concepts, the entirety or portions of components of the semiconductor devices according to various example embodiments of the inventive concepts that have been described above may be implemented as one or more touch chips. For example, the touch chip may be implemented as a single chip so as to include the encoder 50 encoding one or more driving signals provided from the TX driver 30 and providing the encoded one or more driving signals to the touch screen panel 10, along with the TX driver 30 and the RX sensor 40.

In addition, in at least one example embodiment of the inventive concepts, the touch chip may be implemented as a single integrated chip together with a display driver IC (DDI). Specifically, the integrated chip may have a first region and a second region, and the semiconductor device driving the touch screen panel 10 according to various example embodiments of the inventive concepts may be implemented in the first region and the DDI driving a display may be implemented in the second region electrically connected to the first region. In particular, in the case of a display integrated touch screen panel, both functions of the touch chip and functions of the DDI are realized in a single integrated chip in such a manner, whereby a reduction in the area thereof may be allowed.

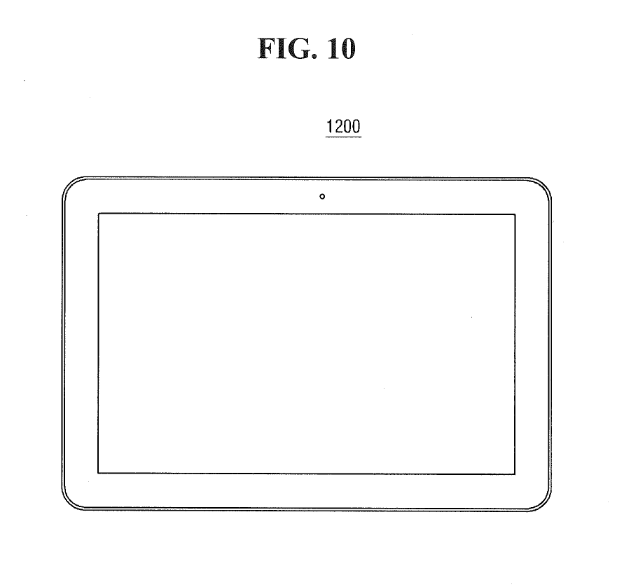

FIG. 10 through FIG. 12 are example semiconductor systems to which the semiconductor devices and the method of operating the same according to the at least one example embodiment of the inventive concepts are applicable.

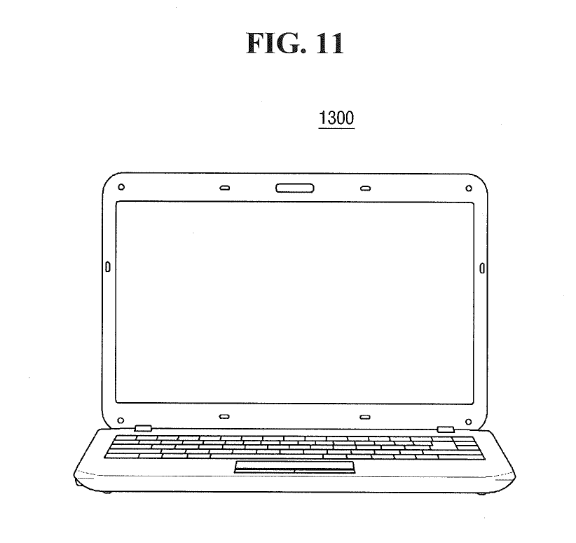

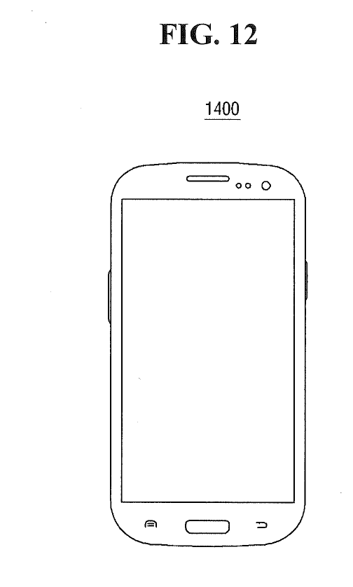

FIG. 10 is a view illustrating a tablet PC 1200, FIG. 11 is a view illustrating a laptop computer 1300, and FIG. 12 is a view illustrating a smartphone 1400. The semiconductor devices and the method of operating the same according to at least one example embodiment of the inventive concepts may be used in the tablet PC 1200, the laptop computer 1300, the smartphone 1400 and the like.

In addition, it may be apparent to a person having ordinary skill in the art that the semiconductor devices and the method of operating the same according to at least one example embodiment of the inventive concepts may be applied to other integrated circuit devices (not shown). That is, in the above description, only the tablet PC 1200, the laptop computer 1300, and the smartphone 1400 are exemplified in the semiconductor devices and the method of operating the same according to example embodiments. However, examples of the semiconductor devices are not limited thereto. In at least one example embodiment of the inventive concepts, the semiconductor devices may be implemented as computers, UMPC (Ultra Mobile PC), workstations, net-book computers, personal digital assistants (PDA), portable computers, wireless phones, mobile phones, e-books, portable multimedia player (PMP), portable game consoles, navigation devices, black boxes, digital cameras, 3-dimensional televisions, digital audio recorders, digital audio players, digital picture recorders, digital picture players, digital video recorders, digital video players and the like.

While example embodiments have been shown and described above, it will be apparent to those skilled in the art that modifications and variations could be made without departing from the spirit and scope of the inventive concepts as defined by the appended claims.

1. A semiconductor device comprising:
a touch screen panel including a plurality of hover sensors configured to perform self-capacitance sensing;
a driver configured to provide a plurality of driving signals to the touch screen panel;
an encoder configured to encode the plurality of driving signals from the driver and provide the encoded plurality of driving signals to the touch screen panel; and
an event sensor configured to sense a hover input from the touch screen panel based on the encoded plurality of driving signals.

2. The semiconductor device of claim 1, wherein the touch screen panel has first lines extending in a first direction and second lines extending in a second direction to intersect the first lines,
the driver is configured to provide the encoded plurality of driving signals to the touch screen panel through the first lines, and
the event sensor is configured to sense the hover input from the hover sensors through the first lines.

3. The semiconductor device of claim 2, further comprising:
a switch array configured to receive the encoded plurality of driving signals from the driver and distribute the encoded plurality of driving signals to a portion of the first lines.

4. The semiconductor device of claim 1, wherein the plurality of driving signals include a first driving signal and a second driving signal, and
the encoder is configured to encode the first and second driving signals such that a sign of an amplitude value of the first driving signal is different from a sign of an amplitude value of the second driving signal.

5. The semiconductor device of claim 1, wherein the plurality of driving signals include a first driving signal and a second driving signal, and
the encoder is configured to encode the first and second driving signals such that a phase of the first driving signal is different from a phase of the second driving signal.

6. The semiconductor device of claim 5, wherein the encoder is configured to encode the first and second driving signals such that a phase of the first driving signal is opposite to a phase of the second driving signal.

7. The semiconductor device of claim 5, wherein the encoder is configured to encode the first and second driving signals such that a voltage level of the second driving signal is the lowest voltage level when a voltage level of the first driving signal is the highest voltage level.

8. The semiconductor device of claim 5, further comprising:
a plurality of switches configured to encode the first driving signal and the second driving signal between the driver and the event sensor.

9. The semiconductor device of claim 1, wherein the encoder is configured to encode the plurality of driving signals according to a first method, at a first time, and encoding the plurality of driving signals according to a second method different from the first method, at a second time subsequent to the first time.

10. The semiconductor device of claim 9, wherein the encoder is configured to encode such that an amplitude of a first driving signal among the plurality of driving signals has a positive value according to the first method at the first time, and such that the amplitude of the first driving signal has a negative value according to the second method at the second time.

11. The semiconductor device of claim 9, wherein the encoder is configured to encode such that a phase of a first driving signal among the plurality of driving signals is a first phase according to the first method at the first time, and such that the phase of the first driving signal is a second phase different from the first phase according to the second method at the second time.

12. The semiconductor device of claim 11, wherein the first phase and the second phase are opposite to each other.

13. The semiconductor device of claim 11, wherein a voltage level of the first driving signal is the highest voltage level at the first time, and
the voltage level of the first driving signal is the lowest voltage level at the second time.

14. The semiconductor device of claim 1, wherein the driver, the event sensor, and the encoder are integrated as a single read-out integrated circuit (ROTC).

15. A semiconductor device comprising:
a touch screen panel including a plurality of hover sensors configured to perform self-capacitance sensing;
a driver configured to provide a single driving signal to the touch screen panel;
a decoder configured to decode a sensing signal into a plurality of sensing signals based on the single driving signal; and
an event sensor configured to sense a hover input from the touch screen panel based on the plurality of sensing signals.

16.-30. (canceled)

31. A semiconductor device comprising:
a driver configured to generate at least one driving signal;
an encoder configured to encode the at least one driving signal and send the encoded at least one driving signal to a touch screen panel, the touch screen panel including a plurality of hover sensors configured to perform self-capacitance sensing based on the at least one driving signal to detect a hover event; and
an event sensor configured to sense the hover event based on output of the hover sensors.

32. The semiconductor device of claim 31, wherein,
the driver is configured to send the encoded at least one driving signal to at least one line extending a desired direction on the touch screen panel, and
the event sensor is configured to sense the hover event from the hover sensors through the at least one line.

33. The semiconductor device of claim 32, further comprising:
a switch array configured to receive the at least one encoded driving signal and distribute the at least one driving signal to the at least one line.

34. The semiconductor device of claim 31, wherein,
the at least one driving signal includes a first driving signal and a second driving signal, and
the encoder is configured to encode the first and second driving signals such that a sign of an amplitude value of the first driving signal is different from a sign of an amplitude value of the second driving signal.

35. The semiconductor device of claim 31, wherein,
the plurality of driving signals include a first driving signal and a second driving signal, and
the encoder is configured to encode the first and second driving signals such that a phase of the first driving signal is different from a phase of the second driving signal.
